(19) United States
(12) Patent Application Publication
(10) Pub. No.: US 2011/0094421 A1
(43) Pub. Date: Apr. 28, 2011

(54) Dry Application Papercrete

(76) Inventor: James Robert Brock, Ranchos de Taos, NM (US)

(21) Appl. No.: 12/604,541

(22) Filed: Oct. 23, 2009

(51) Int. Cl. C04B 7/02

(52) U.S. Cl. 106/737

(57) ABSTRACT

A dry papercrete mix is formed by preparing a wet pulp of fiber material such as newsprint and sharp sand by mixing sand, fiber material and water in a batch or continuous mixer, drying the pulp to a moisture content below that which will cause a reaction with Portland cement and adding additional sands and/or pumice and Portland cement. The resulting dry, granular mix can then be handled stored and used in the manner which is conventional for concrete. The dry papercrete mix can also be applied by pouring the dry papercrete mix into a desired volume such as a form in a dry state and injecting water into the dry papercrete mix until the mix is sufficiently wetted.

### FIELD OF THE INVENTION

The present invention generally relates to concrete-based materials and, more particularly, to concrete compositions including wood/paper fiber as a significant constituent thereof.

### BACKGROUND OF THE INVENTION

Concrete is a mixture of sand and/or gravel and Portland cement and, when mixed with water, forms a slurry that can be molded into virtually any shape. After such mixing, a chemical reaction occurs in the presence of water that causes the slurry to harden over the course of several days (often referred to as curing or, much less accurately, as drying since the concrete must remain hydrated for curing to take place) into an extremely hard, strong and durable material that is highly weather-resistant and thus specially well suited to large structures such as buildings, roads and bridges. Although concrete is much stronger in compression than in tension, reinforcing materials such as iron rods can be embedded in the structure as it is cast in-situ or formed into prefabricated components for later assembly in order to develop overall strength in tension.

However, concrete has several properties that are not optimal for some applications for which it is otherwise well-suited. Specifically, it is very heavy, having a weight per unit volume comparable to stone and, while weight can be desirable in some applications, such as dams, anchors and the like, structures having a large proportion of concrete need very substantial support. Also, Portland cement is very expensive and filler materials such as sand or gravel are usually added to the mixture to a proportion as large as possible without weakening the final cured concrete product.

Further, while concrete has a high specific heat and is capable of storing substantial energy in the form of heat, it is also highly thermally conductive (again, substantially comparable to stone) and thus generally requires insulation if used for the perimeter of buildings. Further, the combination of hardness and weakness in tension causes substantial difficulty in further working (e.g. cutting, drilling, setting nails or screws and the like) of the concrete shapes once they have fully cured. For example, nails to be driven into fully cured concrete must generally be hardened and resistant to bending and require very high force to be applied to drive them into concrete while nails that have been successfully driven may be found to be loose and are not solidly retained by the concrete while the force required to drive them may crack or at least weaken the concrete or cause persistent stresses that may do so over time.

To alter these properties, there has been much interest in concrete compositions having a relatively high content of wood, cellulose or paper fiber therein, especially as a technique for recycling of discarded paper such as newsprint which is generated in large volume. However, while there has been some success in developing such concrete-based compositions, sometimes referred to as papercrete, the processing of paper to obtain a proper consistency by techniques developed to date has proven to be energy-intensive, time-consuming and expensive. Further, mixing of such compositions is difficult (possibly due to the differences in buoyancy and water absorption of wood/paper fiber and other constituent materials) and has generally been done in small batches of a fraction of a cubic yard in a process that is not easily scalable to larger quantities consistent with delivering repeatably acceptable and substantially uniform results.

Another difficulty presented by the use of concrete in construction is the need to build large and strong forms of other materials such as wood or metal when concrete is to be cast in-situ or to form construction modules which can represent a significant cost of the finished structure. When similar shapes are to be formed, some expense can be avoided by re-use of such forms. However, such re-use for in-situ concrete construction is labor intensive and cost savings are marginal but may be economical in forming a large number of similar prefabricated shapes that can later be assembled into a structure.

To avoid some of the labor costs for forming concrete shapes which are largely vertical, however, a technique called slip-forming has been developed which involves multiple pours of concrete mix as the form is incrementally moved. However, this technique has proven somewhat dangerous since sufficient cure of one pour of concrete mix must be sufficient to support the weight of both the next and further subsequent concrete pours as well as the form into which such pours are made and machinery to compact the concrete mix within the form. Numerous construction accidents have occurred when a sufficient cure of the concrete mix is not achieved prior to a subsequent pour. Therefore, slip form techniques are inherently slow, when performed safely. Conversely, if the cure is more complete than necessary for adequate structural support, one pour may not adhere to or integrate sufficiently with a previous pour, leaving regions of weakness and/or persistent, stress within the completed concrete shape.

### SUMMARY OF THE INVENTION

It is therefore an object of the present invention to provide a concrete-based material which includes a substantial fraction of wood/cellulose/paper fiber to reduce density, increase tensile strength and, when cured, has good insulative properties and which can be made, handled and applied as a dry granular material that does not require mixing with water prior to application.

It is another object of the invention to provide a method of use of the concrete-based composition which is easier, faster, more consistent and economical and safer than slip-form concrete casting.

In order to accomplish these and other objects of the invention, a dry papercrete mix is provided comprising pulverized dried pulp of fiber material and sand, additional sand and Portland cement.

In accordance with another aspect of the invention, a method of using a dry papercrete mix comprising a pulp of sand and fiber material and sand, additional sand or pumice and Portland cement is provided comprising steps of pouring dry papercrete mix into a desired volume and injecting water into the dry papercrete mix until the dry papercrete mix is wetted.

In accordance with a further aspect of the invention, a method of preparing a pulp of fiber material and sharp sand is provided comprising steps of mixing fiber material and sharp sand in a ratio of approximately 3:5 with water to form a wet pulp, and drying the wet pulp to a moisture level below that which will react with Portland cement.

In accordance with a yet further object of the invention, a method of preparing a dry papercrete mix is provided comprising steps of mixing fiber material and sharp sand in a ratio of approximately 3:5 with water to form a wet pulp, drying the wet pulp to a moisture level below that which will react with Portland cement to form a dry fiber and sand pulp, and mixing sand and/or pumice and Portland cement with said dry fiber and sand pulp to form said dry papercrete mix.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A is a flow chart illustrating preparation of the concrete composition in accordance with the invention,

FIG. 1B is a cross-sectional view of an apparatus useful in preparation of the dry wood/cellulose/paper fiber component of papercrete in accordance with the invention,

FIGS. 2A and 2B are isometric depictions of a form and other equipment, respectively, which are particularly advantageous for application of the concrete composition in accordance with the invention which also illustrate a method of dry papercrete application in accordance with the invention, and

FIG. 3 is an photograph of a concrete casting of papercrete made using the form and equipment of FIGS. 2A and 2B.

### DETAILED DESCRIPTION OF A PREFERRED EMBODIMENT OF THE INVENTION

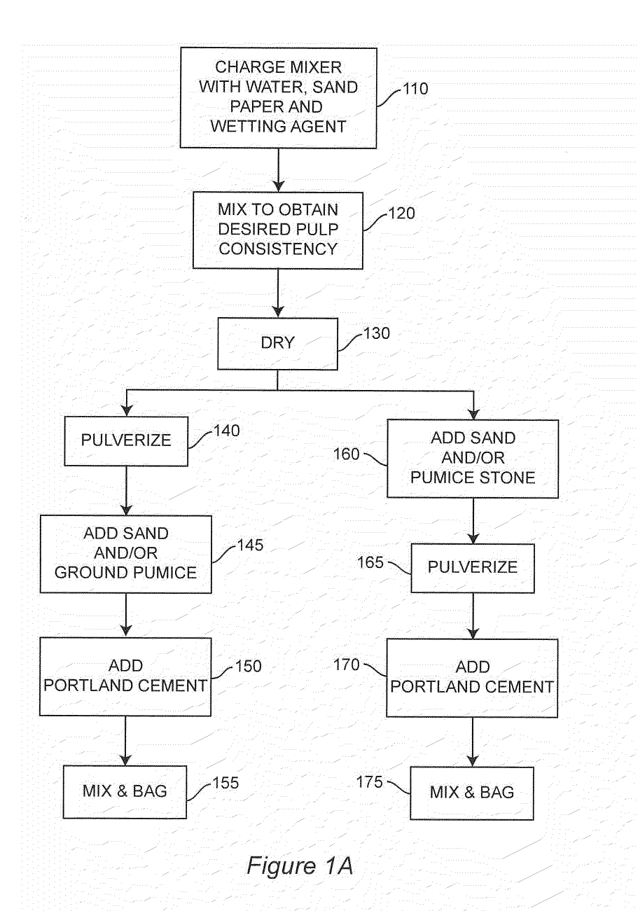

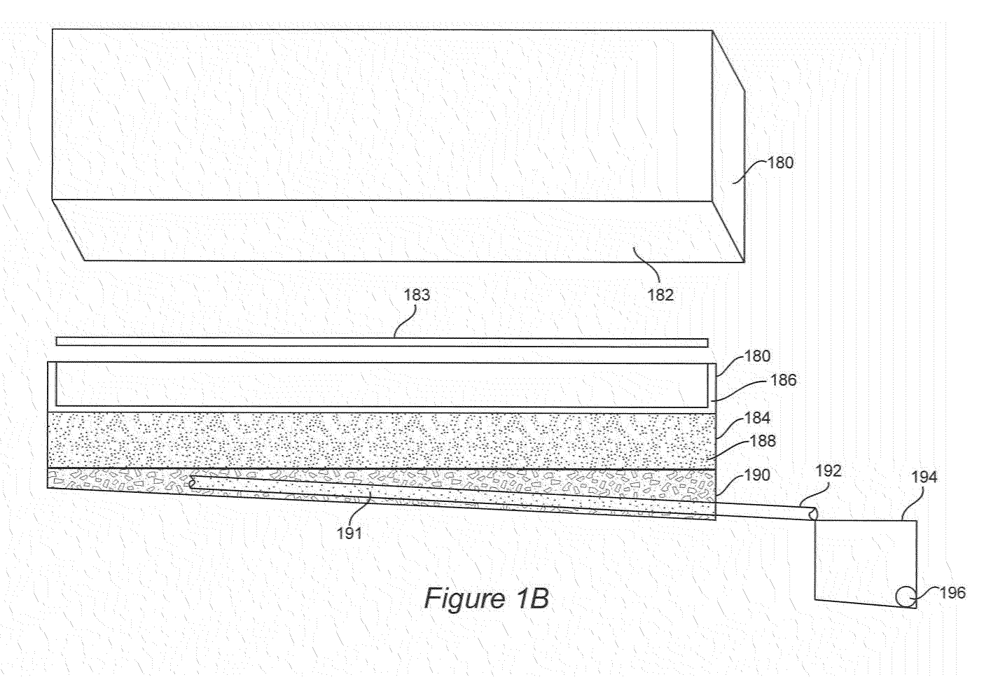

Referring now to the drawings, and more particularly to FIG. 1A, there is shown a flow chart for preparation of the dry application papercrete in accordance with the invention. As alluded to above, while some success has been achieved in developing concrete-based materials having a significant paper, cellulose or wood fiber (hereinafter collectively referred to as wood/paper fiber) content, a major problem of the difficulty of achieving the proper consistency of fibers from the paper, cellulose or recycled wood it is desired to use and the energy required to obtain a useable fiber consistency. The inventor has discovered, as disclosed in U.S. patent application Ser. No. 11/759,435 (which is hereby fully incorporated by reference) that proper fiber consistency can be obtained more quickly and consistently and in an energy-efficient manner by mixing the paper or wood (e.g. in the form of sawdust, shavings or chips) with sand and water (and a small amount of a wetting agent such as soap) in a standard concrete mixer until the desired fiber consistency is achieved. However, this technique was used in the context of preparing a wet application papercrete material for direct use in forms by removing excess water, adding additional sand or gravel and Portland cement to the mixer and continuing to mix the material until ready for pouring into a mold as a wet papercrete mix. Such a procedure, of course, is limited to in-situ, small batch application or the making of prefabricated components of limited size as is also disclosed in the above-incorporated patent application. It does not lend itself to making the material widely available to the public or contractors or to the formation of structures of large size. Moreover, the process is more complex and requires more time and effort than the use of commercially available dry concrete mixes.

In this connection, a distinction must be drawn between so-called dry concrete mixes which are a dry mixture of sand and/or gravel and Portland cement which remain in a granular form until mixed with water in a concrete mixer until it is in a condition to be applied as a wet concrete mix. This distinction will be maintained herein by referring to the former as “dry” or a “dry mix” and which terminology may be applied to the invention, as well, without making any admission of a dry mix containing paper/wood fiber being known in the art or any such admission being inferred by such usage or terminology.

Thus, the invention seeks to provide a product that can be stored, marketed and used much in the manner of current, commercially available dry concrete mixes. Additionally, it has been found that a dry papercrete mix provides additional advantages in handling and application as well as in improved qualities of cured papercrete as will be discussed in greater detail below.

Returning now to FIG. 1A, the preferred method of preparing a dry papercrete mix will now be discussed. It should be noted that the currently preferred technique for preparing a dry papercrete mix is a batch process since commercial quantities are not currently required by the inventor.

However, for preparation of commercial quantities of dry papercrete mix, a more continuous process would be preferred and can be performed using apparatus known in the art for continuous material processing.

Initially, as disclosed in the above-incorporated patent application, a mixer is first charged with a quantity of paper (e.g. newsprint) or other source of wood, paper or other fiber, preferably cellulose but some proportion of other fiber (e.g. cotton, wool or synthetic textile material) composition can be included, as desired. Sharp concrete sand, water and a small amount of wetting agent such as liquid soap are also charged into the mixer as indicated at 110. If found to be desirable or needed for some applications, a mold inhibitor or mildewcide can be included. The proportions of paper, sand and water currently preferred may vary widely depending on several factors which will now be discussed.

It has been found that the wood/fiber pulp produced by the invention has some self-adhesive qualities and, if prepared by agitation in water without the use of sand, and then dried, tends to form clumps which, although the clumps can be easily broken to the desired consistency, requires additional machinery or manual effort to do so. The duration of agitation required to achieve the desired consistency as well as the drying time tends to become extended if no sand is used.

The addition of sharp concrete sand provides a grinding mechanism and aeration that reduces drying time. A sand to wood/paper ratio as low as 5:3 with 50-60 gallons of water provides a pulp that has significantly reduced required times for both the pulping and drying processes although significant clumping will occur. However, only relatively slight clumping effect with clumps that can be much more easily broken is observed at proportions of 200 pounds sand to 30 pounds paper (a sand/wood/paper fiber ratio of about 6.6:1) and 50 gallons of water (and about one to two ounces of wetting agent which is non-critical to the practice of the in invention and which is common to the other examples discussed herein). As the proportion of sand to wood/paper material is increased, the tendency toward clumping substantially disappears at a sand to wood/paper ratio by weight of about 20:1 and, as that ratio is further increased, the amount of water effective for the pulping process can be reduced and aeration is increased; both of which accelerate drying of the pulp. The proportion of sand can also be raised well above the proportion of sand which is desirable in a final dry papercrete mix since excess sand can be easily removed by simple screening and the excess sand reused in subsequent pulping processes and/or included in the final dry papercrete mix.

The proportion of sand in the dried pulp and sand mixture can always be easily determined, particularly in batch processes by its weight and known dry weight of the initial amount of wood/paper included. Such a determination would be somewhat more complicated for a continuous pulping/drying process but can be estimated from the weight of a representative volume and, in any case, is not particularly critical. A proportion of 600 pounds of sand to 15 pounds of wood/paper (a sand to wood/paper ratio of 40:1) has been found to be satisfactory but is considered by the inventor to be possibly somewhat above the optimum ratio or proportion and requires significant handling of sand removed during the drying process. The slight adhesive properties of the wood/paper pulp is sufficient to retain about one-half to two-thirds of the sand that will be desired in the final dry papercrete mix; allowing the excess sand to be readily removed and replaced as needed in the dry papercrete mix. The preferred sand to wood/paper ratio is thus about 20:1 to 35:1 and thirty to forty gallons of water which allows pulping to be completed in only a few minutes while drying can be accomplished in several hours, depending on conditions and proportion of sand.

In this regard, the weights of sand and paper mentioned above correspond to a batch of sand and wood/paper fiber that can be accommodated in a commercially available nine cubic foot concrete mixer. Further, such batches correspond to amounts of pulp that are deemed desirable for a dry papercrete mix that corresponds to inclusion of 94 pounds of Portland cement. Recommended ratios of sand to Portland cement are generally in the range of 5:1 to 6:1 which can be varied somewhat in accordance with the strength requirements for the final cured cement. The self-adhesive properties of the wood/paper pulp as well as the fiber texture (and, possibly, some penetration of Portland cement into the pulp fibers) tends to increase strength and/or allow a somewhat higher sand to Portland cement ratio to be used and results in stronger panels at less cost of constituent materials.

However, batches of other sizes or even a continuous mixer can be used. These ingredients are then mixed until the sand reduces the paper to a pulp having the desired consistency and fiber characteristics as illustrated at 120. For a nine cubic foot mixer, the proper and preferred consistency with a preferred but non-critical average fiber length of about one-sixteenth inch can be achieved in about fifteen minutes or less, depending on the proportion of sand, as noted above. (Other techniques of pulp preparation such as cutting tend to produce an inferior pulp having shorter fiber length.) It is expected that use of larger capacity or continuous mixers would achieve the desired consistency in a shorted time, as well. The pulp is then dried, as illustrated at 130, to a water content which is below that which can cause onset of a curing reaction in Portland cement which will be added to the dry mix at a later point. A commercial drier may be used but simply air drying with solar heat is currently preferred. Adequate dessication of the pulp can be determined by weight which approaches the original weight of paper and sand or desired weight of paper and sand upon removal of excess sand (e.g. to about eighty pounds for thirty pounds of wood/paper) although other testing methods may be employed.

A preferred drying apparatus is illustrated in FIG. 1B. It is preferred to provide a moveable box 180 for holding the wet sand an pulp mixture once the pulping process is completed. This box preferably has solid wood or metal sides and a bottom 182 formed of a layer of expanded (or otherwise perforated) metal sheet which provides support for a filter cloth 186 or, preferably, a wire mesh screen having a mesh size of about one-eighth inch to allow egress of excess sand. The height of sides of the box 180 is not critical and a height of six to eight inches is preferred.

The box 180 is preferably sized to fit upon and be supported by a frame 184 which will serve to catch and hold excess sand that may separate or be separated from the sand and pulp mix. The frame 184 preferably includes a lower portion 190 having an inclined bottom which is preferably filled with pea gravel covering a perforated tube 191 allowing water to drain from frame 184. The pea gravel can also be covered with a layer of sharp concrete sand to allow water to easily percolate therethrough and may include one or more layers of filter cloth to limit sand incursion into the pea gravel.

In use, the wet sand and pulp mixture would be loaded into box 180 either before or after it is place on the frame 184. A pressure plate is preferably applied to provide some mechanical squeezing of moisture from the sand and pulp mixture. The water thus drains into the frame 184, possibly carrying excess sand, which passes through screen 182, filter cloth 186, sand layer 188 and pea gravel 190 and into perforated tube 191 and passes through tube 192 to be collected in a trough or tank 194. The water may then be recovered using a recovery pump 196 and using in further pulping of wood/paper as described above.

Further drying of the sand and pulp mix can be achieved by blowing or drawing air therethrough within the box or simply by evaporation and percolation after removal of the pressure plate. The box may also be removed from the frame at this point and placed in a location or environment where drying will be facilitated (e.g. by sunlight or applied heat and/or natural or forced circulation of air. Again, adequate drying can be determined by weight or other instrumentation which is well-known in the art and can generally be achieved in a very few hour. Excess sand can be removed by shaking or vibrating the box 180 or stirring the sand and pulp mixture before and/or after removal from frame 184.

It should be noted that the above process provides for greater control of fiber qualities than if a wet mixture of papercrete suitable for immediate application were being prepared since additional grinding of the fibers would occur during further mixing with additional sand or gravel and Portland cement. The fiber qualities achieved by the above process may, however, be maintained by using the novel application technique made possible by the dry papercrete mix application methodology in accordance with the invention, as will be described below.

At this point, either of two further processes may be employed which yield similar but subtly different qualities in the dry papercrete mix. Therefore, while either process will produce a dry papercrete mix suitable for most applications, one process may be preferred over the other for particular applications or in dependence on the availability of some materials.

In one of these processes the dried paper pulp and sand mixture is pulverized as shown at 140. Then additional sand and/or equivalent volume of ground pumice and Portland cement is added as shown at 145 and 150, respectively. Total sand (e.g. in the pulp and the additional sand should be in the desired proportion to the amount of Portland cement added at this point. That is, the relative amount of fiber can vary widely while retaining some or all of the advantages of including dry paper pulp to ordinary cry concrete mix formulations and will be discussed in greater detail below. However, for general applications an additional 150 pounds of sand and 94 pounds of Portland sand would be added to approximately eighty pounds of dry fiber and sand pulp produced as described above. These dry ingredients are then mixed thoroughly and placed into moisture-resistant bags or otherwise stored for future distribution and use.

In the other of these processes, additional sand and/or pumice stone (preferably of a one-quarter to one-half inch diameter) is added to the dried pulp and sand mixture and that resulting mix is pulverized as illustrated at 160 and 165, respectively. Portland cement can then be added and mixing and bagging/storage operations 170, 175 performed as before.

It should also be noted in this regard that the use of pumice stone or ground pumice is essentially a filler which is generally of lower cost than sharp sand and is not generally preferred but for that reason. It has been found that pumice granules can flake or dislodge fairly easily and thus pumice content does not provide adhesion properties equal to those of sharp sand either within the cured papercrete or for surface finish materials such as stucco. The reason for this tendency is not known but may be due to a mismatch between the preferred fiber length and pore size of the pumice, Therefore, papercrete mixes with a smaller particle size such as that of sharp sand appear to provide a final product with best advantages over concrete. Nevertheless, replacing all or part of the additional sharp sand with pumice stone or ground pumice yield a satisfactory product for many structural applications.

It should be noted that processes 140, 145 and processes 160, 165 are in essentially the reverse order and processes 160, 165 may use pumice stone whereas processes 140, 145 may use ground pumice. Thus, one or the other of these processes may be preferred based on the availability of either pumice stone or ground pumice. Also, process 160 may be preferred for developing a more uniform grain size in the final mix which may have an effect on the density or finish of the papercrete when applied and cured although process 140 may be preferred to produce lower density and/or a surface texture to which other finish materials may better adhere. Process 140-155 may also be preferred when the addition of gravel is desired that might otherwise interfere with pulverizing process 165. However, gravel can be added to the dry mix subsequent to step 165. In this regard, use of gravel is not preferred since, being stone, it tends to diminish the advantages of papercrete over concrete. However, such deleterious effects can be largely avoided by using so-called pea gravel is relatively small quantities.

The dry papercrete mix as produced by the above method may now be handled and distributed in exactly the same manner(s) as now employed for dry concrete mixes. Moreover, it can be mixed with water and applied in precisely the same ways well-known for the mixing and application of concrete. However, it also provides the distinct advantage of being capable of dry application which is much simpler, more economical and safer than methods which are known for concrete.

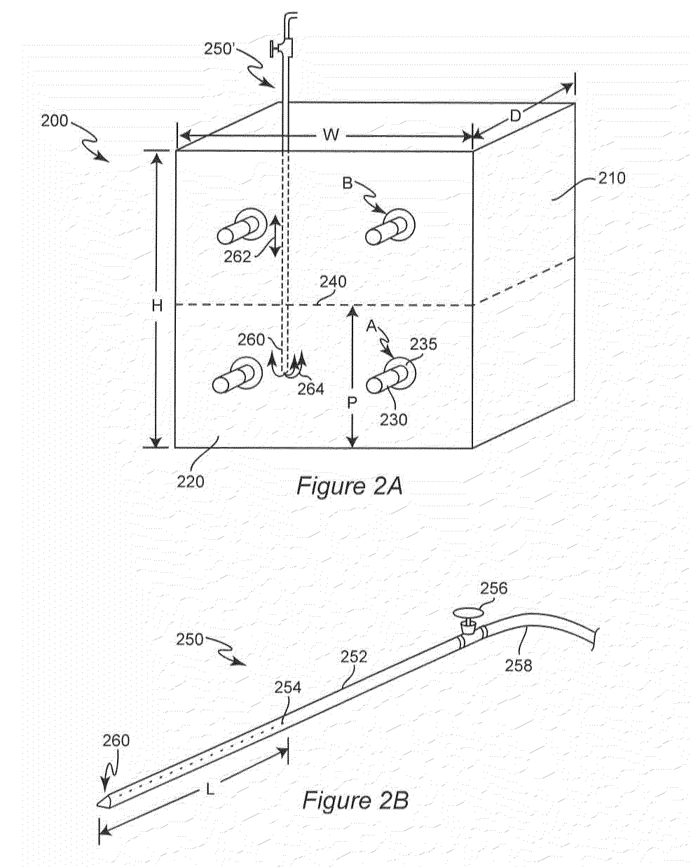

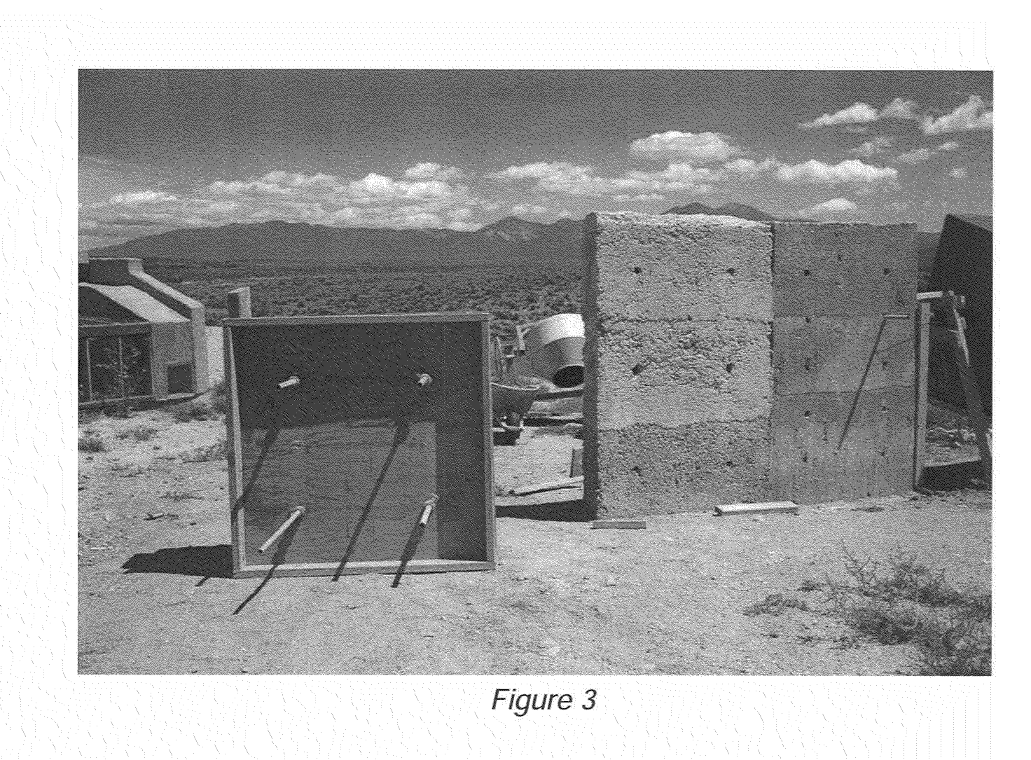

Specifically and with reference to FIG. 2A, an exemplary casting mold is shown which is suitable for casting, for example, a wall section for a structure is shown. Other shapes can also be employed and the size is not at all critical to the practice of the invention. However, for casting a wall panel, a thickness or inside dimension D is preferably about one foot although some tapering may be desired which would preferably be achieved by increasing dimension D at the bottom of the form. Width W is immaterial to the practice of the invention but was about four feet for casting of the wall panel shown in FIG. 3. In this regard, either or both end panels can be omitted and effectively replaced with a previously cast section of the structure or another structure to increase integrity therewith as will be apparent to those skilled in the art. Height H is not critical to the successful practice of the invention but should be chosen as at least twice the depth of a single papercrete “pour” (possibly a misnomer as will be evident from the discussion below although the term is used herein as a parallel process to known concrete forming processes for which the term is more appropriate and well-established in the art) that can be contained by the material and construction of the mold against the pressure of the papercrete within the mold. This exemplary mold was made of ⅝″ plywood which can easily withstand pressures developed by a two foot depth of papercrete, particularly when reinforced with rods 230, in this case conveniently formed by pipes, which extend through front and back panels 220 and which carry clamps 235 which can bear against panels 220 to resist the outward pressure of the papercrete as it sets and cures.

Using such a mold, the dry papercrete mix can be applied in a dry manner by simply pouring the dry mix into the mold, assembled as shown, filling the mold to approximately the level indicated by dashed line 240. (Any desired reinforcement or provision therefor can be laid in place as the dry mix is charged into the mold. A dry mildewcide or mold inhibitor can be introduced at this point if desired and not included earlier in preparation of the paper pulp.) No separate mixing with water is required at this time. Water may then be applied using an apparatus 250 such as that illustrated in FIG. 28 comprising a tube or pipe 252 of convenient length (e.g. somewhat longer than H) having a preferably pointed cap and having holes therein over a length L of the distal end thereof which approximates the anticipated depth of the pour, P. The apparatus is preferably equipped with a fitting to connect to a water supply such as hose 258 and a water control valve 256. A continuous flow mixer such as those used for adding fertilizer to irrigation water may also be employed to add a colorant, mold suppressant, mildewcide or any other incidental material desired to the dry papercrete mix during the wetting process. Such an apparatus is thus similar to a so-called root feeder used to apply liquid fertilizer or other materials to plants at a depth below the surface of the soil. Such a commercially available root feeder can, in fact, be used in the practice of the invention but an apparatus having length L specific to pour depth P is deemed preferable for producing a more uniform distribution of water with less vertical movement than would be required to achieve a similar distribution using a root feeder.

After the dry mix is loaded (hence “pour” may be a misnomer) into mold 200, preferably including application of some vibration to more densely settle the dry mix and to avoid voids (which requires specialized devices to achieve the same effect with a wet mix), apparatus 250 can simply be inserted into the dry mix in the mold (preferably beginning near a corner of the surface of the dry mix) and water applied at sufficient pressure by opening valve 256. The amount of water is not critical and can be determined by inspection since the water will be absorbed more readily by the paper/wood pulp and be distributed through the dry mix radially around the apparatus. When the water so distributed reaches into a corner or a wall of the mold, the water can be turned off at valve 256, apparatus 250 withdrawn and reinserted at another location in the dry mix and water again applied. No voids are formed by the withdrawal of apparatus 250 since the mix will be most wet and will flow most readily where water has been applied although the wicking effect of the paper pulp will rapidly make the water distribution quite uniform thereafter. This process is repeated, preferably in some logical pattern, until water has been applied to the entire volume of dry mix. It is also preferred at this point or up to three to four hours later to tamp down the edges of the mix to further compact the papercrete mix.

While the particular adaptations discussed above in connection with apparatus may seem ideal, the inventor has found that somewhat superior performance of the wetting process for the dry papercrete mix can be achieved with a substantially simpler apparatus which is simply a piece of pipe or tubing of convenient length which is open at the end 260, omitting peripheral holes 254. A one-half inch nominal diameter of the tube is preferred for use in connection with a mold an “pour” of the scale described above but other sizes may be used for other applications. Such as embodiment is shown at 250′ of FIG. 2A. With such an apparatus, the flow of water at a preferred pressure of thirty yo forty-five psi may be continuous during the wetting process. The water flow from the end 260 of the apparatus at such a pressure will displace and more thoroughly mix particles of the dry papercrete mix as generally indicated by arrows 264 in FIG. 2A and allow the apparatus 250′ to be simply plunged repeatedly with little force into the dry papercrete mix and withdrawn (as indicated by double arrow 262) in accordance with some systematic pattern to provide coverage throughout the dry papercrete mix while accommodating any reinforcement structures that may have been applied. Water discharged on top of the papercrete mix, if not excessive, is of generally salutary effect in properly hydrating the papercrete. Additionally any need to apply vibration to the dry papercrete mix to settle it, as described above, especially around any reinforcement structures that may be included, is avoided and any differential settling of components of the dry papercrete mix are substantially or fully counteracted by the additional agitation provided by the water flow.

It should be appreciated that the preferential absorption of water by the paper/wood pulp avoids any need to separately mix water with the dry mix in the manner that is conventional for concrete prior to application to the mold or otherwise applied. By the same token, the technique described above can be used instead of such “normal” mixing if, for example, the papercrete is to be applied for filling of holes or forming horizontal structures such as paved surfaces or applied with a trowel or the like. It should also be appreciated that the preferential absorption and distribution of water throughout the mix makes the amount of water applied substantially less critical than with concrete mixes and retains water throughout the body of applied papercrete to enhance curing. (Portland cement can be observed adhering to the paper pulp in the dry mix and such adhesion may be enhanced as water is distributed by wicking through the pulp.) With known concrete mixes, excess water tends to escape the mold while carrying Portland cement with it. Very little Portland escapes from the wetted papercrete mix even if excess water is applied. It is preferred to apply water to the point of forming a puddle of shallow depth on top of the wetted dry mix. The water in the puddle will protect the surface from drying prematurely (and interfering with the cure) while providing a small reservoir for water to be further distributed to the remainder of the papercrete by the wicking action of the paper pulp.

In this regard, application of the above formulation with a trowel is considered to be less than ideal and it is believed that a lower paper/wood fiber concentration would improve wetted papercrete mix for trowel application. Further, for hole filling or forming any generally horizontal structure that may require strength very similar to that of concrete, addition of dry paper/fiber and sand pulp prepared as described above in a concentration of as low as 3% to 5% by weight will allow the dry application of conventional dry concrete mixes using in-situ wetting as described above. Both of these possible variant formulations are considered to be within the scope of the present invention.

After the papercrete is allowed to cure for approximately one day, the cure will not be complete but will be sufficient for a further “pour” to be made by filling the remainder of the mold or form 200 or a lesser portion thereof with dry papercrete mix and applying water with apparatus 250 or 250′ as before. The newly applied papercrete is then allowed to cure for about one day.

At this point, the pipes or rods 230 can be withdrawn and the mold moved up until the hole in the mold or form originally at location A registers with a hole in the cast papercrete at location B, at which point a further “pour” can be made as described above. At this point, the papercrete exposed by the shifting of the mold or form has cured for two days and is quite strong but will continue to cure and increase in strength as the mold or form is repeatedly shifted and additional “pours” made. However, depending of the cumulative weight bearing on the base (e.g. due to the cumulative height), it is preferred to allow two days curing time between “pours” which allows additional curing and development of additional strength of earlier “pours” as the overall height and weight of the structure increases. It has been found that subsequent “pours” still adhere very well after two days of curing of previous “pours”. Thus, height of the structure can be built up very rapidly with simple and easily performed movement of the mold while avoiding of exposure of the cast papercrete until adequate cure has occurred, and adequate strength developed to avoid collapse up to perhaps ten feet or more. Heights of eight feet have been achieved with no indication of possible collapse using only one day curing time between subsequent “pours”.

The resulting wall section(s) are shown with the mold used to make them in the photograph of FIG. 3. As can be seen, while the respective “pours” can be identified, adhesion between them is quite good. It can also be seen that the depth of each pour is not at all critical to the successful practice of the invention and the spacing of holes for reinforcing rods or pipes 230 (which defines the minimum shift of the mold or form) is similarly not at all critical and may be adjusted to assure a desired cure consistent with good adhesion as height is built up. Note that the wall section on the right has holes spaced more closely and includes one shallow pour immediately above the initial pour. While the wall section on the right required one additional day to form, the initial pour would have cured for one additional day before the mold or form was moved to obtain additional strength to support the fourth and subsequent pours. By the same token, it can be seen that the depth of pours can be adjusted to add smaller increments of weight over time while still keeping the frequency of pours to two days or less for good adhesion.

Further, it can be seen from FIG. 3 that the top surfaces can be left as rough as desired to enhance adhesion to a subsequent pour. Additionally, a wide variety of surface textures can be achieved with different sizes to which the dried pulp and/or pumice are pulverized and different degrees of settling of the dry mix in the mold or form. Therefore, the surface texture and density can be controlled to a substantial degree by slight variation of the molding or forming process.

In view of the foregoing, it is clearly seen that the invention provides a dry mix papercrete product that can be stored, distributed and used at least as easily as known and commercially available dry concrete mixes; allowing the properties of papercrete to be obtained as easily as storage, distribution and use of concrete which does not possess those properties. Moreover, a dry papercrete mix allows a technique of dry application which is substantially easier than techniques applicable to concrete and provides superior papercrete qualities to those obtained which conventional concrete application techniques are used. Additionally, the adhesion of plaster, stucco or the like is excellent and no lath or screening is required. The cured papercrete accepts nails and screw-type fasteners well at much lower forces than for cured concrete and retains them well. Further, the thermal resistance of “R factor” for dry application papercrete in accordance with the preferred formulation discussed above is about 2 per inch, making the insulation qualities comparable to that of a fiberglass-insulated wood-frame wall of similar thickness that allows for required air circulation to avoid moisture condensation therein.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A dry papercrete mix comprising pulverized dried pulp of fiber material and sand, additional sand and Portland cement.

2. A dry papercrete mix as recited in claim 1, further including ground pumice or pulverized pumice stone.

3. A dry papercrete mix as recited in claim 1 wherein said pulp of fiber material and sand includes fiber and sand in the approximate proportion, by weight, of 3:5.

4. A dry papercrete mix as recited in claim 1 wherein said pulp of fiber material and sand includes fiber and sand in the approximate proportion, by weight, of less than 3:5.

5. A dry papercrete mix as recited in claim 1 wherein the content of fiber material and sand is in the range of 3% to 5%, by weight.

6. A method of using a dry papercrete mix comprising a pulp of sand and fiber material and sand, additional sand or pumice and Portland cement, said method comprising steps of
pouring said dry papercrete mix into a desired volume, and
injecting water into said dry papercrete mix until said dry papercrete mix is wetted throughout said desired volume.

7. A method as recited in claim 6, wherein said desired volume is a form.

8. A method as recited in claim 7, wherein said form can be shifted for repeating said steps of pouring and injecting water.

9. A method as recited in claim 6, wherein said step of injecting water is performed by
causing a flow of water in a pipe, and
repeatedly plunging said pipe into said dry papercrete mix and withdrawing it, whereby said flow of water agitates said dry papercrete mix as it is wetted.

10. A method as recited in claim 9, wherein said step of repeatedly plunging said pipe into said dry papercrete mix and withdrawing it is performed over a pattern.

11. A method of preparing a pulp of fiber material and sharp sand, said method comprising steps of
mixing sharp sand and fiber material in a ratio of approximately 5:3 to 40:1 with water to form a wet pulp, and
drying said wet pulp to a moisture level below that which will react with Portland cement.

12. A method as recited in claim 11, wherein said mixing step is performed until an average fiber length of approximately one-sixteenth inch is obtained.

13. A method as recited in claim 11, wherein said mixing step is performed in a concrete mixer.

14. A method as recited in claim 11, wherein said mixing step is performed in a continuous mixer.

15. A method of preparing a dry papercrete mix, said method comprising
mixing sharp sand and fiber material in a ratio of approximately 5:3 to 40:1 with water to form a wet pulp,
drying said wet pulp to a moisture level below that which will react with Portland cement to form a dry fiber and sand pulp, and
mixing sand and/or pumice and Portland cement with said dry fiber and sand pulp to form said dry papercrete mix.

16. A method as recited in claim 15, wherein said method includes a further step of
placing said dry papercrete mix in moisture-resistant bags.
